(19) United States
(12) Patent Application Publication
(10) Pub. No.: US 2014/0047102 A1
(43) Pub. Date: Feb. 13, 2014

(54) NETWORK MONITORING

(71) Applicants: Harvadan Nagoria NITIN, Bangalore (IN); Martin Bosler, Wannweil (DE); Amit Kumar, Bangalore (IN)

(72) Inventors: Harvadan Nagoria NITIN, Bangalore (IN); Martin Bosler, Wannweil (DE); Amit Kumar, Bangalore (IN)

(21) Appl. No.: 13/571,214

(22) Filed: Aug. 9, 2012

(51) Int. Cl. G06F 15/173

(52) U.S. Cl. 709/224

(57) ABSTRACT

A system may include a monitoring engine to monitor configuration items of each layer of a multilayer network in a synchronized fashion in which each layer is monitored at a predefined time interval following monitoring of configuration items of another layer.

### BACKGROUND

Networks, such as those provided in datacenters, include various configuration items. Configuration items may represent hardware (e.g., servers, processors, routers, switches, etc.) and/or software (e.g., an operation system) that is configurable in some way. Configuration items may be used to implement, for example, a network in a datacenter. The various configuration items may be organized in layers thereby forming the network. One layer may be an application layer, while other layers may be an infrastructure layer and a database layer.

### BRIEF DESCRIPTION OF THE DRAWINGS

For a detailed description of various examples, reference will now be made to the accompanying drawings in which:

FIG. 1 shows an example of a system;

FIG. 2 shows an example of an implementation of the system of FIG. 1;

FIG. 3 shows an example of a data structure;

FIG. 4 shows an example of a timeline illustrating synchronized network monitoring; and

FIG. 5 shows an example of a method.

### DETAILED DESCRIPTION

As noted above, a network includes various configuration items coupled together. A datacenter, for example, is represented as numerous configuration items. Users may desire to monitor such configuration items for a variety of reasons. For example, failures of configuration items need to be identified and resolved. By way of another example, a user may want to monitor processor utilization. Processor utilization greater than a threshold may be symptomatic of a network being overloaded with traffic and that additional processor resources may need to be brought on-line.

A network may comprise a collection of computing entities, software, and related connectivity devices. Networks may be organized as layers with each layer including at least one configuration item and, in some examples, a plurality of configuration items. An example set of network layers include an application layer, an infrastructure layer, and a database layer. Different or additional layers may be provided in other implementations. The configuration items of the application layer include various applications that run on the network such as business applications, word processing applications, etc. The configuration items of the infrastructure layer comprise the various hardware and software items that implement the network. Examples of infrastructure layer configuration items include server computers, processors, routers, switches, data storage devices, operating systems, etc. The applications of the application layer run on some of the configuration items of the infrastructure layer. The database layer includes one or more databases that are accessible to the infrastructure layer and/or the application layer.

In some networks, each layer may be monitored for events (e.g., out of limit behavior) according to a predefined time interval. However, there is no synchronization of the monitoring between layers. For example, each layer may be monitored on a 6 minute time interval meaning that each layer is monitored every 6 minutes for events. But without synchronization between the layers, all three layers may be monitored at around the same time, which in turn means that close to 6 minutes may elapse between monitoring actions.

Some detected events may directly indicate a problem while other detected events may be a symptom of a problem but not the underlying problem itself. For example, an event associated with an application may be detected indicating that the application is not performing as expected. The underlying cause of the problem could be a bug in the application itself or may be a problem with the memory of the server that is executing the application. In the latter case, there may be no bug in the application itself but nevertheless the application is detected as functioning incorrectly. Such problems can be diagnosed by detecting an event with one configuration item in one layer of the network (e.g., an application) and then tracing that event to another configuration item in another layer to determine if it is the root cause of the problem. Lack of synchronization of monitoring between the layers of some networks may slow down the diagnosis of problems that implicate the interplay between layers. In the 6 minute monitoring example provided above, it may take a monitoring solution up to 6 minutes to diagnose a problem with a network. The embodiments described herein provide a more efficient monitoring solution that expedites problem diagnosis.

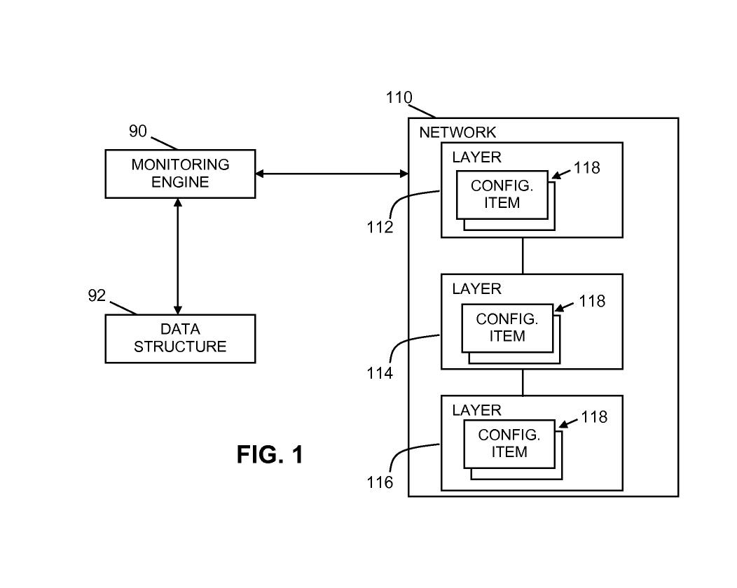

FIG. 1 shows a system in accordance with an example. The system of FIG. 1 shows a monitoring engine 90 that may access a data structure 92 and a network 110.

The network 110 includes various configuration items (Cls) 112. The configuration items 118 are represented in a plurality of layers 112, 114, and 116. Each configuration item 112 represents an item of hardware and/or software that is configurable. Examples of configuration items include servers, switches, routers, storage devices, processor, operating systems, etc. Any software and/or hardware item in a network that is configurable in some way may be considered to be a configuration item. In one example, layer 112 may be an application layer, while layers 114 and 116 are infrastructure and database layers, respectively. Each layer includes one or more configuration items and each configuration item may be hardware, software, or a combination of hardware and software.

The monitoring engine 90 monitors the various layers 112, 114, and 116 of the network 110, and specifically monitors the configuration items 118 of the various layers. The monitoring engine 90 measures, estimates, computes, or otherwise determines one or more metrics pertaining to each configuration item. An example of a metric for a processor type of configuration item may be processor utilization. An example of a metric for a storage device type of configuration item may be the amount of free storage available for use. In general, the metrics can be whatever metrics are desired to be monitored for the various configuration items. The metrics to be monitored for each type of configuration item (type of configuration item being server, processor, operating system, etc.) are stored in the data structure 92. As such, the monitoring engine 90 accesses the data structure 92 to determine which metrics to monitor for each configuration item 118 in the network 110 and then performs monitoring actions on the network to determine the various required metrics. The monitoring engine 90 detects the occurrence of events (e.g., a configuration item that is not performing as expected as described herein) associated with the various configuration items.

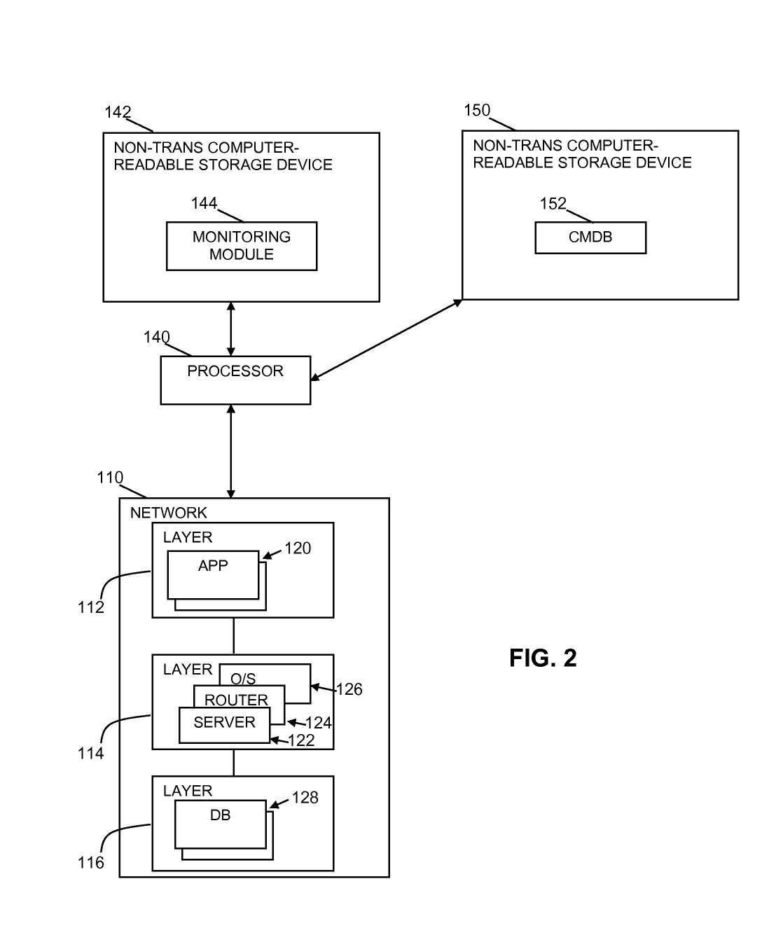

FIG. 2 illustrates an example of an implementation of the system of FIG. 1. FIG. 2 shows a processor 140 coupled to non-transitory computer-readable storage devices 142 and 150 as well as to the network 110. Each non-transitory computer-readable storage device 142, 150 may be implemented as volatile memory (e.g., random access memory), non-volatile storage (e.g., hard disk drive, optical disk, electrically-erasable programmable read-only memory, etc.) or combinations of both volatile and non-volatile storage devices. Non-transitory computer-readable storage device 142 contains a monitoring module 144 which comprises software that is executable by processor 140. The processor 140 executing monitoring module 144 is an example of an implementation of the monitoring engine 92 of FIG. 1. All actions attributed herein to the monitoring engine 90 may be performed by the processor 140 upon execution of the monitoring module 144.

The non-transitory computer-readable storage device 150 contains the database 92 from FIG. 1 which in FIG. 2 is represented as a configuration management database (CMDB) 152.

The network in FIG. 2 is shown to include an application layer 112 which may include one or more configuration items in the form of applications 120. The network 110 also includes an infrastructure layer 114 which may include a server 122, a router 124, an operating system (O/S) 126 and other types of numbers of configuration items of various hardware or software network infrastructure items. The applications 120 of the application layer 112 run on one or more configuration items (e.g., servers 122) of the infrastructure layer 114. The database layer 116 includes one or more configuration items in the form of databases 128 for use by the infrastructure or application layers 114 and 112.

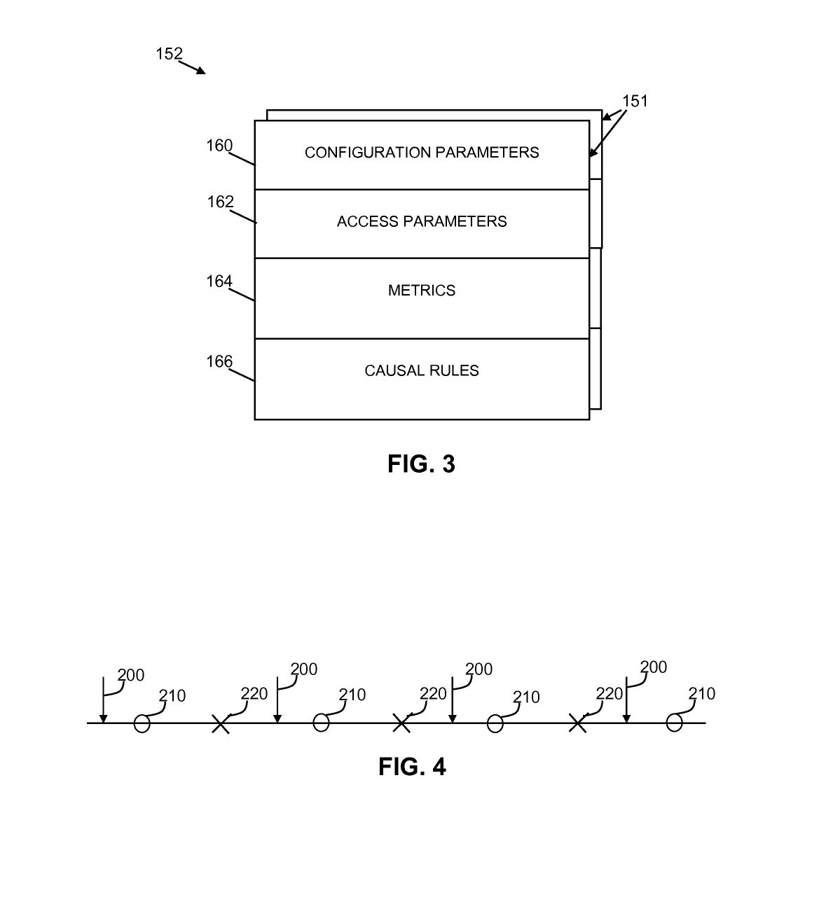

FIG. 3 shows an example of the CMDB 152. In the example of FIG. 3, for each configuration item the CMDB 152 includes a record 151 that may store the following pieces of information: configuration parameters 160, access parameters 162, metric information 164, and causal rules 166. Different or additional pieces of information may be included as well. The configuration parameters 160 include a list of the specific parameters that are configurable for the particular configuration item. For example, in the case of a processor, the configuration parameters may include an alert that is triggered if the processor becomes too hot or the processor utilization becomes too high. In the case of a redundant array of independent discs (RAID) storage subsystem, the configuration parameters may include an alert triggered by a disk failure, a performance bottleneck, etc. The access parameters 162 include information indicative of how to access each configuration item. Such access parameters may include an address (e.g., an Internet Protocol (IP) address), instance name of a database server, etc.

The metric information 164 includes one or more identifications that identify individual metrics. The metrics identified by the metric identifications include any type of value or parameter that may be measured, computed, or calculated for a given configuration item. An example of a metric for a processor may be processor utilization. An example of a metric for a storage subsystem may be the amount of used storage and/or the amount of available storage. An event is identified by the monitoring engine 90 if a performance metric for a configuration item falls outside an acceptable range as specified by a corresponding metric in metric information 164.

Causal rules 166 specify cause-symptom relationships between configuration items including relationships between configuration items in different layers. The causal rule(s) for a given configuration item identify another configuration item whose performance may be effected by improper behavior of the given configuration item. For example, failure of a server may, and probably will, detrimentally impact any applications running on that server. A problem with a database may impact any application that uses that database. In general, the operation of any one configuration item may impact one or more other configuration items, and the causal rules identify configuration items related in that manner. In one implementation, the causal rules for a given configuration item may simply be a list of the identities of other configuration items that may be impacted by improper behavior of the given configuration item.

In accordance with various examples, each network layer or a configuration item within a layer is monitored according to a predefined time interval. For example, a given configuration item may be monitored at 6 minute time intervals meaning that the monitoring engine 90 performs a monitoring action on that particular configuration item every six minutes based on the metrics specified in the data structure 92 (e.g., CMDB 152) for the configuration items in that layer. Some or all configuration items may be monitored in accordance with a predefined time interval. The time interval may be the same or different as between the configuration items of the various layers. The monitoring of the configuration items of the layers by the monitoring engine 90 may be based on a predefined time interval in a synchronized fashion as explained below. The monitoring engine 90 imposes a starting time for the various monitoring events in a distributed, coordinated fashion based on the time interval between monitoring events and the number of layers in the system, as described below.

FIG. 4 illustrates an example of a time line. Arrows 200 depict the monitoring of one of the layers (and one or more of its configuration items) of the network at 6 minute time intervals. Thus arrows 200 are shown at time T, T+6, T+12, T+18, etc. Arrows 210 depict the monitoring of a different network layer also at 6 minute time intervals, but spaced apart from the monitoring events represented by arrows 200 by two minutes. Thus arrows 210 (and thus the corresponding monitoring events) are shown at time T+2, T+8, T+10, T+20, etc. Similarly, arrows 220 depict the monitoring of yet a different network layer and also at 6 minute time intervals, but spaced apart from the monitoring events represented by arrows 210 by two minutes. Thus arrows 220 (and thus the corresponding monitoring events) are shown at time T+4, T+10, T+16, etc. The synchronization of the monitoring events between the layers in the network is such that each layer is monitored at a predefined time interval following monitoring of another layer (in this illustrative case a 2 minute time interval).

The illustrative timing of FIG. 4 may apply to all configuration items within the various layers. Alternatively, different configuration items in a given layer may be monitored in accordance with a different timing pattern. For example, a group of configuration items in a given layer may be monitored at 6 minute intervals while other configuration items in the same layer may be monitored at 30 minute intervals. Thus, the 2-minute distributed timing pattern described above may apply only to a subset of the configuration items in the various layers, with other subsets of configuration items being monitored according to a different timing pattern.

During a periodic monitoring action (such as may occur at points 200, 210, and 220), the monitoring engine 90 may detect an “event.” An event is a metric of a configuration item that is outside its normal, expected range. For example, if processor utilization is expected to be in the range of 5% to 50%, a processor utilization of 90% will be flagged as an event for the corresponding processor. The expected value of each metric may be pre-programmed into the monitoring engine 90. An event may be an indication of an error with the corresponding configuration item, or the event may simply be symptomatic of an error with another configuration item. In the case of processor utilization being monitored for a given processor, a utilization level of 90% may mean that another processor in the network has failed thereby causing an increased workload on the given processor.

Once the monitoring engine 90 detects an event for a given configuration item in a given layer, the monitoring engine 90 accesses the data structure 92 (CMDB 152) to determine if a causal rule 166 is provided for that particular configuration item. If a causal rule is not provided, the monitoring engine 90 may report the event and continue monitoring the network according to the synchronized, predefined time intervals.

If, however, a causal rule is provided in the data structure for the configuration item for which an event has been detected, the monitoring engine 90 then immediately performs a monitoring action on any other configuration items specified any such causal rules. This monitoring action is outside the time synchronized monitoring discussed above. This immediate monitoring action assists the monitoring engine 90 to diagnose the problem with the network much faster than would have been the case if only the timed monitoring was implemented. The monitoring action triggered by the causal rule may be to monitor a configuration item in a different layer or in the same layer as the detected event.

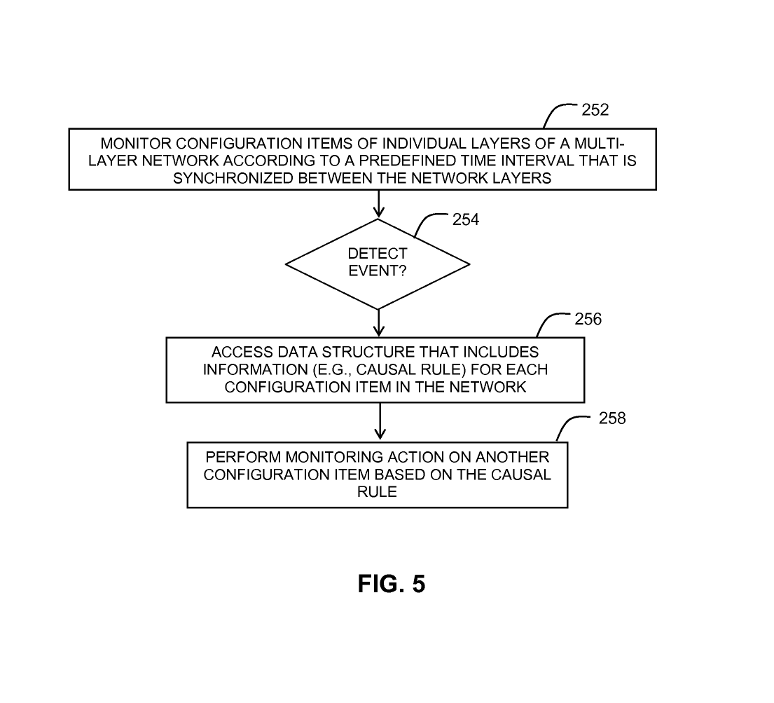

FIG. 5 shows a method in accordance with an example. The actions depicted in FIG. 5 may be performed in the order shown, or in a different order, and two or more of the actions may be performed in parallel, rather than serially. The actions depicted in FIG. 5 may be performed by the monitoring engine 90.

At 252, the method includes monitoring configuration items of individual layers of a multi-layer network according to a predefined time interval that is synchronized between the network layers. At 254, the monitoring engine 90 detects whether an event has occurred with a given monitored configuration item. If no event has occurred, control continues at 252.

If an event has occurred, then at 256, the method includes accessing the data structure 92 that includes information for each configuration in the network. The information may include a causal rule for the given configuration item for which an event has been detected. At 258, the method then includes performing a monitoring action on another configuration item based on the causal rule.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a monitoring engine to monitor configuration items of each layer of a multilayer network in a distributed fashion in which configuration items of each layer are monitored at a predefined time interval following monitoring of configuration items of another layer.

2. The system of claim 1 wherein the system further comprises a data structure containing a causal rule for each of multiple configuration items, each causal rule specifying a relationship between the causal rule's configuration item and another configuration item.

3. The system of claim 2 wherein the causal rule specifies a cause-symptom relationship between configuration items.

4. The system of claim 2 wherein the data structure is a configuration management database that includes, for each configuration item, metrics to be monitored.

5. The system of claim 2 wherein, upon the monitoring engine detecting an event associated with a given configuration item, the monitoring engine is to access the data structure to determine if another configuration item is related to the event's configuration item.

6. The system of claim 5 wherein, if another configuration item is related to the event's configuration item, the monitoring engine is to determine whether an event has occurred with the related configuration item.

7. The system of claim 6 wherein the monitoring engine is to determine whether an event has occurred before a next scheduled monitoring interval occurs.

8. The system of claim 1 wherein monitoring engine imposes a starting time for monitoring events of the configuration items based on a time interval between monitoring events and the number of layers of the network.

9. The system of claim 1 wherein the monitoring engine is to detect events associated with the configuration items, wherein an event indicates a configuration item is not performing as expected.

10. A non-transitory, computer-readable storage device storing software that, when executed by a processor, causes the processor to:
monitor configuration items of individual layers in a multilayer network;
upon detecting an event of one of the configuration items, access a data structure that includes information for each configuration item, the information including a causal rule that establishes a relationship between that configuration item and a configuration item in another layer; and
perform a monitoring action on another configuration item based on a causal rule in the data structure associated with the configuration for which the event was detected.

11. The non-transitory, computer-readable storage device of claim 10 wherein the software causes the processor also to monitor configuration items of individual layers of the network in a distributed fashion in which configuration items of each layer are monitored at a predefined time interval following monitoring of configuration items of another layer.

12. The non-transitory, computer-readable storage device of claim 10 wherein the software causes the processor to determine from the causal rule another configuration item to monitor upon detecting an event with the configuration item to which the causal rule is associated in the data structure.

13. The non-transitory, computer-readable storage device of claim 10 wherein the data structure is a configuration management database that includes, for each configuration item, metrics to be monitored.

14. The non-transitory, computer-readable storage device of claim 10 wherein the software causes the processor to detect an event by identifying a configuration item that is not performing as expected.

15. The non-transitory, computer-readable storage device of claim 10 wherein the event is detected by identifying a configuration item performing outside an acceptable range as specified by a corresponding metric in the data structure.

16. The non-transitory, computer-readable storage device of claim 10 wherein the causal rule specifies a cause-symptom relationship between configuration items.

17. A method, comprising:
monitoring configuration items of individual layers of a multilayer network according to a predefined time interval for each layer that is synchronized between the configuration items of the layers;
detecting an event associated with a configuration item;
based on detecting the event, accessing a data structure that includes information for each configuration item, the information including a causal rule that establishes a relationship between that configuration item and a configuration item in another layer; and
performing a monitoring action on another configuration item based on a causal rule in the data structure associated with the configuration for which the event was detected.

18. The method of claim 17 further comprising computing a starting time for monitoring events of the configuration items based on the number of layers of the network.

19. The method of claim 18 further comprising computing the starting time for monitoring events of the configuration items based on the number of layers of the network and a time interval between the monitoring events.

20. The method of claim 17 wherein detecting the event comprises detecting a configuration item not to performing as expected.
